(19) United States
(12) Patent Application Publication
(10) Pub. No.: US 2026/0124602 A1
(43) Pub. Date: May 7, 2026

(54) ORGANIC MATTER DECOMPOSITION CATALYST, HONEYCOMB STRUCTURE, METHOD FOR DECOMPOSING ORGANIC MATTER, AND ORGANIC MATTER DECOMPOSITION DEVICE

(71) Applicant: Murata Manufacturing Co., Ltd., Nagaokakyo-shi (JP)

(72) Inventors: Hideto SATO, Nagaokakyo-shi (JP); Satoshi KURETAKE, Nagaokakyo-shi (JP); Soichiro TSUJIMOTO, Nagaokakyo-shi (JP)

(21) Appl. No.: 19/436,201

(22) Filed: Dec. 30, 2025

Related U.S. Application Data
(63) Continuation of application No. PCT/JP2024/026744, filed on Jul. 26, 2024.

(30) Foreign Application Priority Data
Aug. 3, 2023 (JP) 2023-127136

(51) Int. Cl. B01J 23/34; B01D 53/86; B01D 53/96; B01J 23/00; B01J 23/92; B01J 35/57; B01J 37/00; B01J 37/04; B01J 37/06; B01J 37/08; B01J 38/02

(52) U.S. Cl. CPC B01J 23/34; B01D 53/8609; B01D 53/864; B01D 53/96; B01J 23/002; B01J 23/92; B01J 35/57; B01J 37/0018; B01J 37/0036; B01J 37/04; B01J 37/06; B01J 37/08; B01J 38/02; B01D 2255/2068; B01D 2255/20715; B01D 2255/2073; B01D 2255/9155; B01D 2257/302; B01D 2257/7027; B01D 2258/06; B01J 2523/3725; B01J 2523/48; B01J 2523/72

(57) ABSTRACT

An organic matter decomposition catalyst that contains a ternary composite oxide containing zirconium, manganese, and neodymium and oxidatively decomposes organic matter. Also disclosed is a honeycomb structure, a method for decomposing organic matter, and an organic matter decomposition device that use the organic matter decomposition catalyst.

### CROSS REFERENCE TO RELATED APPLICATIONS

The present application is a continuation of International application No. PCT/JP2024/026744, filed Jul. 26, 2024, which claims priority to Japanese Patent Application No. 2023-127136, filed Aug. 3, 2023, the entire contents of each of which are incorporated herein by reference.

### TECHNICAL FIELD

The present disclosure relates to an organic matter decomposition catalyst and also relates to an organic matter decomposition structure, a method for decomposing organic matter, and an organic matter decomposition device.

### BACKGROUND ART

Purification of exhaust gas composed of hydrocarbon organic compounds commonly involves mixing the exhaust gas with an oxygen-containing gas, such as air, and heating the resulting mixture so that the hydrocarbon organic compounds are decomposed into water and carbon dioxide through an oxidation combustion reaction. Using a catalyst material enables exhaust gas purification at lower temperatures and higher rates, and therefore, the use of a catalytic exhaust gas purification device can reduce the energy and costs associated with exhaust gas treatment. Common catalysts include active components, such as platinum, palladium, manganese, and cobalt, supported on ceramics, such as alumina. Noble metals, such as platinum and palladium, enable exhaust gas treatment at lower temperatures than manganese- or cobalt-based catalysts, but noble metals are expensive.

Patent Document 1 proposes a BaZr(Mn)O₃ catalyst (BZM-type catalyst) for the purpose of improving the heat resistance of perovskite-type composite oxide catalysts. Non Patent Document 1 and Non Patent Document 2 propose Zr—Mn-based catalysts for the purpose of suppressing degradation during the decomposition of Cl-containing hydrocarbon gases. Patent Document 2 proposes that the characteristics of Zr—Mn-based catalysts are improved by performing hydrothermal treatment and high-temperature steam treatment during the process for producing Zr—Mn-based catalysts.
Patent Document 1: Japanese Unexamined Patent Application Publication No. 2015-229137
Patent Document 2: Chinese Patent No. 111790374

### Non Patent Documents

Non Patent Document 1: Jose I. Gutierrez-Ortiz et al., “Structure of Mn—Zr mixed oxides catalysts and their catalytic performance in the gas-phase oxidation of chlorocarbons,” Chemosphere, 2007, Vol. 68, pp. 1004-1012
Non Patent Document 2: D. Doebber et al., “MnOx/ZrO2 catalysts for the total oxidation of methane and chloromethane,” Applied Catalysis B: Environmental, 2004, Vol. 52, pp. 135-143

### SUMMARY OF THE DISCLOSURE

Common exhaust gas decomposition catalysts include platinum group metals, such as platinum, rhodium, and palladium, supported on heat-resistant materials, such as alumina. In many catalysts in which an active component is supported on a carrier, such as alumina, fine particles of the active component are supported on the carrier to achieve high catalytic activity. As a result, the activity of the catalyst tends to easily degrade due to a reduction in material surface area. In many cases, catalysts used for exhaust gas decomposition treatment are exposed to high-temperature environments resulting from high-temperature exhaust gas and heat generation associated with the decomposition reaction. In addition, platinum, rhodium, and palladium are rare resources and expensive, and cost constraints may make it difficult to introduce a large amount of such metals into a large-scale catalytic exhaust gas treatment device.

If a catalyst has insufficient heat resistance or poisoning resistance, its catalytic performance deteriorates in a short period, and it is thus difficult to use catalytic exhaust gas treatment, which tends to increase the energy costs for exhaust-gas treatment. Therefore, there is a need for catalysts that can be used stably at higher temperatures and catalyst materials resistant to degradation by catalyst poisoning components, such as sulfur(S), chlorine (Cl), and phosphorus (P).

The BZM catalyst disclosed in Patent Document 1 has improved heat resistance; however, when exposed to exhaust gas containing a high concentration of S or Cl, the BZM catalyst may exhibit degradation in catalytic characteristics as a result of reactions between these elements and the catalyst components.

The Zr—Mn-based catalysts disclosed in Non Patent Document 1, Non Patent Document 2, and Patent Document 2 exhibit resistance to chlorinated hydrocarbons, but have insufficient heat resistance at higher temperatures. When the exhaust-gas treatment temperature reaches a high temperature, the catalyst particles may aggregate, reducing the contact area between the catalyst and the gas and thereby degrading the exhaust gas purification performance. Since aggregation of catalyst particles causes deformation of the catalyst itself, cracking of pellet catalysts or peeling in catalyst-coated honeycomb structures may occur, generating dust and raising concerns about adverse effects on exhaust-gas treatment equipment and downstream processes.

Thus, catalysts are required to have sufficiently high heat resistance in consideration of not only the operating temperature of the exhaust-gas treatment equipment but also the temperature rise accompanying the combustion of organic matter and the possibility of increasing the operating temperature to compensate for insufficient treatment capacity.

The present disclosure is directed to: an organic matter decomposition catalyst that can exhibit high catalytic activity in the initial activity, can maintain high catalytic activity even in the catalytic activity after poisoning, and can be regenerated by heating even after being poisoned; and a honeycomb structure, a method for decomposing organic matter, and an organic matter decomposition device that use the organic matter decomposition catalyst.

The organic matter decomposition catalyst according to the present disclosure is an organic matter decomposition catalyst for oxidatively decomposing organic matter. The organic matter decomposition catalyst contains a ternary composite oxide containing zirconium, manganese, and neodymium.

The present disclosure can provide: an organic matter decomposition catalyst that can exhibit high catalytic activity in the initial activity, can maintain high catalytic activity even in the catalytic activity after poisoning, and can be regenerated by heating even after being poisoned; and a honeycomb structure, a method for decomposing organic matter, and an organic matter decomposition device that use the organic matter decomposition catalyst.

### BRIEF DESCRIPTION OF THE DRAWINGS

FIG. 1 is a schematic view of an organic matter decomposition device of the present disclosure.

FIG. 2 illustrates the XRD measurement results for organic matter decomposition catalysts of Examples 6, 10, and 19.

FIG. 3 illustrates TEM (transmission electron microscope) images and EDX (energy dispersive X-ray spectroscopy) elemental mapping images of the organic matter decomposition catalyst of Example 10.

FIG. 4 is a schematic view of an organic matter decomposition device used in Examples.

### DESCRIPTION OF THE PREFERRED EMBODIMENTS

Organic matter decomposition catalysts according to embodiments of the present disclosure will be described below with reference to the drawings. In the following description of the embodiments, the same or equivalent parts in the drawings are denoted by the same reference signs, and their descriptions are not repeated.

### <Organic Matter Decomposition Catalyst>

An organic matter decomposition catalyst according to the present disclosure is for oxidatively decomposing organic matter. The organic matter decomposition catalyst contains a ternary composite oxide (hereinafter also referred to as first oxide) containing zirconium (Zr), manganese (Mn), and neodymium (Nd). In this description, a ternary composite oxide refers to an oxide that contains three elements in addition to oxygen and that is a compound having a stable crystal structure.

The first oxide may be an oxide containing Zr, Mn, and Nd. The presence of the first oxide in the organic matter decomposition catalyst can be confirmed by X-ray diffraction (XRD) analysis or by elemental mapping using energy-dispersive X-ray spectroscopy (EDX) with a transmission electron microscope (TEM). XRD analysis or TEM-EDX analysis confirms that the crystal structure of the first oxide is a solid solution where Mn and Nd are dispersed and incorporated within the crystal lattice of zirconium oxide (Zro₂).

Examples of the organic matter to be oxidatively decomposed by the organic matter decomposition catalyst include hydrocarbon gases, sulfur compounds, and nitrogen compounds. The organic matter may be, for example, volatile organic compounds (VOCs). The organic matter decomposition catalyst of the present disclosure is particularly suitable for the oxidative decomposition of hydrocarbon gases (e.g., aromatic hydrocarbons, alcohols, ketones, aldehydes, and carboxylic acids). The organic matter decomposition catalyst is used, for example, for purifying harmful gases, such as exhaust gases.

The oxidative decomposition is described by using, as an example, the toluene combustion reaction represented by the following formula (1):

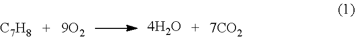

In this reaction, hazardous toluene, which is subject to atmospheric emission restrictions, is converted into harmless water vapor and carbon dioxide when reacted with air (oxygen). Since this reaction is exothermic, the reaction zone is heated to a high temperature, particularly when treating high-concentration gases or large-volume gases. When the hydrocarbons constituting hydrocarbon gases contain sulfur or chlorine elements in their organic structures, sulfur or chlorine reacts with catalyst components or is strongly bonded to adsorption sites on the catalyst surface, leading to poisoning and subsequent degradation of catalyst performance.

Organic matter decomposition catalysts containing the first oxide tend to exhibit improved heat resistance. This may be because adding both Mn and Nd to ZrO₂ increases the number of active sites and thus enhances organic matter decomposition performance, while the change in the surface energy of ZrO₂ inhibits crystal grain growth and improves heat resistance. As a result, even when calcined at a high temperature (e.g., 900° C.) during the production process or when used at high temperatures, the organic matter decomposition catalyst of the present disclosure tends to easily exhibit high catalytic activity in the initial activity, tends to easily maintain high catalytic activity even in the catalytic activity after poisoning, and tends to be easily regenerated by heating even after being poisoned. The initial activity, the catalytic activity after poisoning, and the catalytic activity after regeneration are evaluated according to the methods described in the section of Examples below.

An organic matter decomposition catalyst containing the first oxide can exhibit higher catalytic activity in the initial activity and can maintain higher catalytic activity even in the catalytic activity after poisoning, than an organic matter decomposition catalyst being free of the first oxide and containing a binary composite oxide. An organic matter decomposition catalyst containing the first oxide can exhibit higher catalytic activity in the initial activity and can maintain higher catalytic activity even after being poisoned than, for example, an organic matter decomposition catalyst being free of the first oxide and containing a binary composite oxide containing Zr and Mn, and an organic matter decomposition catalyst being free of the first oxide and containing a binary composite oxide containing Nd and Zr. This is because adding both Mn and Nd to ZrO₂ allows Mn and Nd to be easily dispersed in ZrO₂, compared with a binary composite oxide containing either Mn or Nd. As a result, more active sites enhance organic matter decomposition performance and reduce the surface energy of ZrO₂ to inhibit crystal grain growth, improving heat resistance.

The organic matter decomposition catalyst of the present disclosure can exhibit higher catalytic activity in the initial activity and can maintain higher catalytic activity even in the catalytic activity after poisoning, than an organic matter decomposition catalyst being free of the first oxide and containing a mixture of a binary composite oxide containing Zr and Mn and a binary composite oxide containing Nd and Zr.

The organic matter decomposition catalyst may further contain an oxide that exhibits catalytic activity (hereinafter also referred to as second oxide) in addition to the first oxide. The second oxide may contain, for example, one or two or more oxides containing manganese or neodymium. The second oxide may be, for example, a single-component oxide or a binary composite oxide. Specific examples of the second oxide include Mn₃O₄, Mn₂O₃, and Nd₂O₃. The organic matter decomposition catalyst may contain, as oxides exhibiting catalytic activity, only the first oxide, or only the first oxide and the second oxide.

The organic matter decomposition catalyst may be composed only of the first oxide or only of the first oxide and the second oxide. The organic matter decomposition catalyst may contain a binder or an organic solvent in order to form particles or a honeycomb as described below, or to facilitate coating on a structure. The amount of the first oxide in the organic matter decomposition catalyst may be, for example, 100 mass % or less, 95 mass % or less, or 90 mass % or less, and may be 50 mass % or more, based on the mass of the organic matter decomposition catalyst. In a structure coated with the organic matter decomposition catalyst, such as a honeycomb structure coated with the organic matter decomposition catalyst described below, the mass of the organic matter decomposition catalyst refers to the mass of the organic matter decomposition catalyst coated on the structure and does not include the mass of the structure (e.g., honeycomb-shaped ceramic).

When the organic matter decomposition catalyst contains the second oxide, the amount of the second oxide may be, for example, 40 parts by mass or less, preferably 30 parts by mass or less, and may be, for example, more than 0 parts by mass, per 100 parts by mass of the first oxide.

The molar ratio of Mn to Zr in the organic matter decomposition catalyst may be, for example, in the range of 0.02 to 1.00, preferably in the range of 0.05 to 0.70. When the molar ratio of Mn to Zr in the organic matter decomposition catalyst is within the above range, the organic matter decomposition catalyst has improved heat resistance and as a result, tends to easily exhibit high catalytic activity in the initial activity, tends to easily maintain high catalytic activity even in the catalytic activity after poisoning, and tends to be easily regenerated by heating even after being poisoned.

The molar ratio of Nd to Zr in the organic matter decomposition catalyst may be, for example, in the range of 0.002 to 0.200, preferably in the range of 0.010 to 0.150. When the molar ratio of Nd to Zr in the organic matter decomposition catalyst is within the above range, the organic matter decomposition catalyst has improved heat resistance and as a result, tends to easily exhibit high catalytic activity in the initial activity, tends to easily maintain high catalytic activity even in the catalytic activity after poisoning, and tends to be easily regenerated by heating even after being poisoned.

The organic matter decomposition catalyst may contain a monoclinic ZrO₂ crystal phase (first crystal phase). The first crystal phase may be a solid solution crystal phase in which Mn and Nd are dispersed and incorporated. The organic matter decomposition catalyst may contain one or two or more crystal phases (second crystal phases) in addition to the first crystal phase. The second crystal phase can include, for example, an Mn₃O₄ crystal phase, an Mn₂O₃ crystal phase, an Nd₂O₃ crystal phase, a cubic ZrO₂ crystal phase, and a tetragonal ZrO₂ crystal phase. The organic matter decomposition catalyst can be identified by XRD analysis.

In the organic matter decomposition catalyst, the molar ratio of manganese to zirconium may be 0.05 or more, and the molar ratio of neodymium to zirconium may be 0.01 or more, and when the (−111) plane diffraction peak intensity of monoclinic ZrO₂ in XRD is denoted by A, the (011) plane diffraction peak intensity of Nd₂O₃ is denoted by B, the (103) plane diffraction peak intensity of Mn₃O₄ is denoted by C, and the (222) plane diffraction peak intensity of Mn₂O₃ or the (211) plane diffraction peak intensity of NdMnO₃ is denoted by D, (B+C+D)/A may be 0.9 or less. With these features, the organic matter decomposition catalyst can maintain high activity (toluene 90% decomposition temperature≤350° C.) even after calcination at 900° C. Because of high heat resistance, the catalyst whose catalytic performance has deteriorated due to poisoning can be regenerated by heating. The catalyst containing at least predetermined amounts of Mn and Nd relative to the monoclinic ZrO₂ serving as the main phase has improved catalytic activity. The catalyst containing excess Mn and Nd has increased amounts of secondary phases, such as Mn₃O₄, Mn₂O₃, NdMnO₃, and Nd₂O₃, as determined from the XRD measurement results. The Mn and Nd in these secondary phases may reduce the catalytic activity because they undergo grain growth at high temperatures instead of being dispersed on ZrO₂. When the ratio of the XRD peak intensity of the main phase (monoclinic ZrO₂) to the total XRD peak intensity of the secondary phases (Mn₃O₄, Mn₂O₃, NdMnO₃, and Nd₂O₃) (hereinafter referred to as secondary phase/main phase peak ratio) is 0.9 or less as determined from the XRD measurement results, it is easy to suppress a decrease in activity. The A, B, C, and D are determined according to the methods described in the section of Examples.

The organic matter decomposition catalyst can be prepared, for example, as follows. First, pebbles, water, and an organic binder are added to ZrO₂, Mn₃O₄, and Nd₂O₃ and mixed to obtain a mixture. Mixing can be performed using a ball mill or similar equipment. Next, the mixture is dried in an oven at a temperature of 120° C., then ground and classified to obtain particles having a particle size of approximately several hundred micrometers to several millimeters. Subsequently, the resulting sample in particle form is calcined in air at a temperature of 900° C. for 2 hours. This can yield the organic matter decomposition catalyst.

The temperature at which the organic matter decomposition catalyst can exhibit catalytic activity in the initial activity may be, for example, 300° C. to 510° C., preferably 310° C. to 460° C.

The temperature at which the organic matter decomposition catalyst can exhibit catalytic activity after poisoning may be, for example, 400° C. to 700° C., preferably 420° C. to 620° C., more preferably 420° C. to 540° C.

The temperature at which the organic matter decomposition catalyst can exhibit catalytic activity after being regenerated by heating may be, for example, 300° C. to 700° C., preferably 340° C. to 540° C., more preferably 340° C. to 470° C.

Since the organic matter decomposition catalyst has improved heat resistance, can exhibit high catalytic activity in the initial activity, can maintain high catalytic activity even in the catalytic activity after poisoning, and can be regenerated by heating even after being poisoned, the organic matter decomposition catalyst is suitable for decomposing volatile organic compounds (VOCs), which are generated in processes, such as painting, molding, combustion, and waste disposal in living environments and industrial fields, to cause environmental pollution. The organic matter decomposition catalyst can be used for purifying automobile exhaust gases and for other applications.

### <Form of Organic Matter Decomposition Catalyst>

The organic matter decomposition catalyst can be used, for example, in the form of a pellet catalyst having a particle size of several millimeters to several centimeters, and a honeycomb catalyst obtained by processing into a honeycomb shape. By coating the surface of a honeycomb-shaped ceramic with the organic matter decomposition catalyst, the organic matter decomposition catalyst can also be used as a honeycomb structure coated with the organic matter decomposition catalyst. The honeycomb shape can reduce the pressure loss when gas flows through the structure. Increasing the cell density of the honeycomb increases the effective surface area and thus can easily enhance the decomposition rate of the organic matter.

### <Method for Decomposing Organic Matter>

A method for decomposing organic matter according to another embodiment of the present disclosure is a method for decomposing organic matter including a decomposition step of oxidatively decomposing organic matter by heating the organic matter using the organic matter decomposition catalyst described above. In the decomposition step, the organic matter can be decomposed by heating the organic matter while keeping the organic matter in contact with the organic matter decomposition catalyst. The foregoing description of organic matter applies to this organic matter. The method for decomposing organic matter can be conducted using the organic matter decomposition device described below.

The heating temperature in the decomposition step may be, for example, 300° C. to 900° C. When the heating temperature in the decomposition step is in the above range, the organic matter decomposition catalyst can exhibit catalytic activity and can exhibit catalytic activity even after poisoning. To suppress catalyst performance degradation and reduce energy costs, the heating temperature in the decomposition step is preferably 300° C. to 700° C., more preferably 300° C. to 600° C., still more preferably 300° C. to 540° C.

A method for heating the organic matter while keeping the organic matter in contact with the organic matter decomposition catalyst can involve, for example, packing the organic matter decomposition catalyst in a pipe, introducing the organic matter into the pipe, and heating the contact area between the organic matter decomposition catalyst and the organic matter in the pipe from the outside of the pipe. The organic matter decomposition catalyst packed in the pipe can be the pellet catalyst, the honeycomb catalyst, or the honeycomb structure coated with the organic matter decomposition catalyst as described above. The organic matter decomposition catalyst may also be an aggregate of the organic matter decomposition catalyst.

The method for decomposing organic matter can further include a regeneration step of recovering the catalytic activity by heating the organic matter decomposition catalyst used in the decomposition step to a temperature higher than or equal to the heating temperature in the decomposition step. The regeneration step can be performed by heating the organic matter decomposition catalyst used in the decomposition step at a temperature higher than or equal to the heating temperature in the decomposition step while keeping the organic matter decomposition catalyst in contact with air. The organic matter decomposition catalyst used in the decomposition step may have been poisoned by S, Cl, P, or other elements.

The temperature higher than or equal to the heating temperature in the decomposition step may be, for example, 300° C. to 900° C. From the viewpoint of the catalytic activity of the regenerated catalyst and the energy costs, the temperature is preferably 400° C. to 800° C., more preferably 600° C. to 800° C.

A method for heating the organic matter decomposition catalyst used in the decomposition step while keeping the organic matter decomposition catalyst in contact with air can involve, for example, introducing air into the pipe packed with the organic matter decomposition catalyst used in the decomposition step, and heating the organic matter decomposition catalyst from the outside of the pipe.

### <Organic Matter Decomposition Device>

An organic matter decomposition device according to another embodiment of the present disclosure includes a pipe through which organic matter flows and a heater that heats the organic matter flowing through the pipe. The organic matter decomposition catalyst described above is disposed in a region that is located within the pipe and heated by the heater.

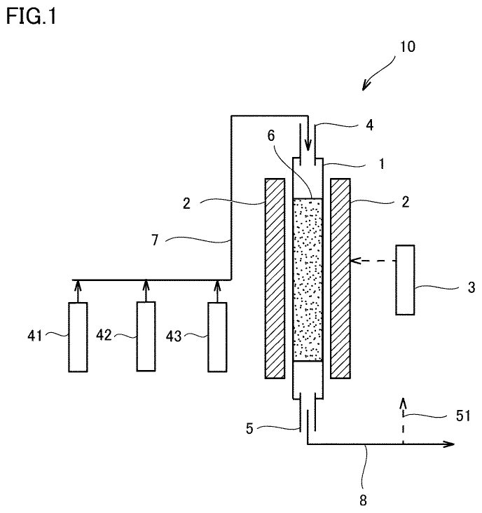

The organic matter decomposition device will be described with reference to FIG. 1. An organic matter decomposition device 10 illustrated in FIG. 1 includes a pipe 1 through which organic matter flows, a heater 2 that heats the organic matter flowing through the pipe 1, and a controller 3 that controls the heater 2.

An organic matter decomposition catalyst 6 is disposed in a region that is located within the pipe 1 and heated by the heater 2. The organic matter decomposition catalyst 6 may be the above organic matter decomposition catalyst, and the form of the organic matter decomposition catalyst 6 may be an aggregate, or the pellet catalyst, the honeycomb catalyst, or the honeycomb structure coated with the organic matter decomposition catalyst as described above.

The pipe 1 has a gas inlet 4 on its upstream side. The gas inlet 4 is connected to a gas supply pipe 7. On the upstream side of the pipe 1, the gas supply pipe 7 is connected to an organic matter supply line 41 for supplying organic matter (e.g., toluene), a nitrogen supply line 42 for supplying nitrogen (N₂), and an oxygen supply line 43 for supplying oxygen (O₂). Specifically, a gas to be treated containing organic matter, nitrogen, and oxygen is supplied to the pipe 1 through the gas supply pipe 7.

The pipe 1 has a reaction gas outlet 5 on its downstream side. The reaction gas outlet 5 is connected to the gas discharge pipe 8 through which the treated gas after the organic matter has been decomposed in the pipe 1 is discharged out of the system. The gas discharge pipe 8 is connected to a sampling line 51 for sampling the treated gas, and this configuration enables analysis of the concentration of the organic matter in the treated gas by gas chromatography.

The controller 3 is configured to perform control such that the temperature of the region heated by the heater 2 is, for example, 300° C. to 900° C.

The controller 3 is configured to control the heater 2 such that the temperature of the organic matter decomposition catalyst 6 is 300° C. to 900° C. Controlling the temperature of the organic matter decomposition catalyst 6 in the range of 300° C. to 900° C. can enhance the catalytic activity of the organic matter decomposition catalyst 6. Controlling the temperature of the organic matter decomposition catalyst 6 at 900° C. or lower can suppress degradation of the organic matter decomposition catalyst 6.

The organic matter decomposition catalyst 6 after organic matter decomposition can undergo a regeneration treatment to recover the catalytic activity of the organic matter decomposition catalyst 6. The regeneration treatment involves, while supplying oxygen and nitrogen to the pipe 1 without supplying organic matter, heating the organic matter decomposition catalyst 6 using the heater 2 such that the temperature of the organic matter decomposition catalyst 6 is higher than or equal to the heating temperature in the decomposition step under the control of the controller 3. Since the regeneration treatment aims to desorb catalyst poisoning components through heating, the organic matter decomposition catalyst needs to be heated to a temperature higher than or equal to the operating temperature. The regeneration treatment can also be performed while supplying organic matter.

### EXAMPLES

The present disclosure will be described in more detail by way of Examples. Unless otherwise specified, “%” and “parts” in Examples represent percent by mass and parts by mass, respectively. The analysis of the organic matter decomposition catalysts of Examples and Comparative Examples described below using a fluorescence X-ray analyzer identified the compositions of the organic matter decomposition catalysts described in Tables 1 and 2.

### Example 1

ZrO₂, Mn₃O₄, and Nd₂O₃ were used as raw materials for an organic matter decomposition catalyst and weighed such that the molar ratio of Zr:Mn:Nd was 1.00:0.10:0.002, and pebbles, water, and an organic binder were added to the raw materials and mixed. The resulting mixture was dried in an oven at 120° C., then ground, and classified to produce particles of 0.5 to 0.7 mm. The obtained sample in particle form was calcined in air at 900° C. for 2 hours to yield an organic matter decomposition catalyst of Example 1.

### Example 2

An organic matter decomposition catalyst of Example 2 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.10:0.005.

### Example 3

An organic matter decomposition catalyst of Example 3 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.10:0.010.

### Example 4

An organic matter decomposition catalyst of Example 4 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.10:0.020.

### Example 5

An organic matter decomposition catalyst of Example 5 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.10:0.050.

### Example 6

An organic matter decomposition catalyst of Example 6 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.10:0.100.

### Example 7

An organic matter decomposition catalyst of Example 7 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.10:0.150.

### Example 8

An organic matter decomposition catalyst of Example 8 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.10:0.200.

### Example 9

An organic matter decomposition catalyst of Example 9 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.01:0.100.

### Example 10

An organic matter decomposition catalyst of Example 10 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.05:0.100.

### Example 11

An organic matter decomposition catalyst of Example 11 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.15:0.100.

### Example 12

An organic matter decomposition catalyst of Example 12 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.20:0.100.

### Example 13

An organic matter decomposition catalyst of Example 13 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.40:0.100.

### Example 14

An organic matter decomposition catalyst of Example 14 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.70:0.100.

### Example 15

An organic matter decomposition catalyst of Example 15 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:1.00:0.100.

### Example 16

An organic matter decomposition catalyst of Example 16 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.02:0.002.

### Example 17

An organic matter decomposition catalyst of Example 17 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.02:0.150.

### Example 18

An organic matter decomposition catalyst of Example 18 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.40:0.002.

### Example 19

An organic matter decomposition catalyst of Example 19 was produced in the same manner as in Example 1, except that ZrO₂, Mn₃O₄, and Nd₂O₃ were used as raw materials for the organic matter decomposition catalyst and weighed such that the molar ratio of Zr:Mn:Nd was 1.00:0.40:0.150.

### Example 20

An organic matter decomposition catalyst of Example 20 was produced by performing the same process from mixing to calcination as in Example 1, except that Zro₂, Mn₃O₄, and Nd₂O₃ were used as raw materials for the organic matter decomposition catalyst and weighed such that the molar ratio of Zr:Mn:Nd was 1.00:0.10:0.250.

### Comparative Example 1

BaCO₃, ZrO₂, and Mn₃O₄ were used as raw materials for an organic matter decomposition catalyst and weighed such that the molar ratio of Ba:Zr:Mn was 1.00:0.90:0.10, and pebbles, water, and an organic binder were added to the raw materials and mixed. The resulting mixture was dried in an oven at 120° C., then ground, and classified to obtain particles of 0.5 to 0.7 mm. The obtained sample in particle form was calcined in air at 1000° C. for 2 hours to yield an organic matter decomposition catalyst of Comparative Example 1.

### Comparative Example 2

An organic matter decomposition catalyst of Comparative Example 2 was produced by performing the same process from mixing to calcination as in Example 1, except that ZrO₂ and Mn₃O₄ were used as raw materials for the organic matter decomposition catalyst and weighed such that the molar ratio of Zr:Mn was 1.00:0.02.

### Comparative Example 3

An organic matter decomposition catalyst of Comparative Example 3 was produced by performing the same process from mixing to calcination as in Example 1, except that ZrO₂ and Nd₂O₃ were used as raw materials for the organic matter decomposition catalyst and weighed such that the molar ratio of Zr:Nd was 1.00:0.10.

### [Crystal Phase Identification]

The organic matter decomposition catalysts of Examples and Comparative Examples were ground in a mortar, and the crystal phases were identified by powder XRD measurement (X-ray source: Cu-Kal). The types of crystal phases detected in the organic matter decomposition catalysts of Examples and Comparative Examples are shown in Table 1.

### [Measurement of Secondary Phase/Main Phase Peak Ratio]

To quantify the amount of the secondary phase components, Mn₃O₄, Mn₂O₃, NdMnO₃, and Nd₂O₃, identified by powder XRD measurement relative to monoclinic ZrO₂ serving as the main phase of the catalyst, the results obtained by calculating the secondary phase/main phase peak ratio, which was the ratio of the “sum of the diffraction peak intensities of the secondary phase components” to the “diffraction peak intensity of the main phase component”, as determined from the powder XRD measurement results are shown in Table 1. The maximum diffraction peak intensities from the following crystal planes were used as the diffraction peak intensities for the respective crystal phases.
A: The diffraction peak intensity of the (−111) plane of the monoclinic phase ZrO₂ at 2θ=27.5 to 28.8 degrees
B: The diffraction peak intensity of the (103) plane of Nd₂O₃ at 2θ=30.6 to 31.0 degrees
C: The diffraction peak intensity of the (103) plane of Mn₃O₄ at 2θ=32.1 to 32.5 degrees
D: The diffraction peak intensity of the (222) plane of Mn₂O₃ or the diffraction peak intensity of the (211) plane of NdMnO₃ at 2θ=32.6 to 33.2 degrees

Since the strongest lines of Mn₂O₃ and NdMnO₃ appear in the same intensity region, the maximum intensity of the diffraction peak at 2θ=32.6 to 33.2 degrees was taken as the peak intensity of both Mn₂O₃ and NdMnO₃.

TABLE 1

| | Composition of Organic Matter | | | |
|---|---|---|---|---|
| | Decomposition Catalyst | | | |
| | Molar Ratio of | Molar Ratio of | | |
| | Mn to Zr in | Nd to Zr in | | Secondary |
| | Organic Matter | Organic Matter | | Phase/Main |
| | Decomposition | Decomposition | | Phase Peak |
| | Catalyst | Catalyst | Type of Crystal Phase | Ratio |
| Example 1 | 0.1 | 0.002 | m-ZrO₂, Mn₃O₄ | 0.1 |
| Example 2 | 0.1 | 0.005 | m-ZrO₂, Mn₃O | 0.1 |
| Example 3 | 0.1 | 0.01 | m-ZrO₂, Mn₃O | 0.1 |
| Example 4 | 0.1 | 0.02 | m-ZrO₂, Mn₃O | 0.3 |
| Example 5 | 0.1 | 0.05 | m-ZrO₂, NdMnO₃ | 0.4 |
| Example 6 | 0.1 | 0.1 | m-ZrO₂, NdMnO₃ | 0.6 |
| Example 7 | 0.1 | 0.15 | m-ZrO₂, NdMnO₃, Nd₂O₃ | 0.9 |
| Example 8 | 0.1 | 0.2 | m-ZrO₂, NdMnO₃, Nd₂O₃ | 1.7 |
| Example 9 | 0.02 | 0.1 | m-ZrO₂, Nd₂O₃ | 0.5 |
| Example 10 | 0.05 | 0.1 | m-ZrO₂ | 0.3 |
| Example 11 | 0.15 | 0.1 | m-ZrO₂, NdMnO₃ | 0.6 |
| Example 12 | 0.2 | 0.1 | m-ZrO₂, NdMnO₃, Nd₂O₃ | 0.6 |
| Example 13 | 0.4 | 0.1 | m-ZrO₂, Mn₃O₄, NdMnO₃, Nd₂O₃ | 0.7 |
| Example 14 | 0.7 | 0.1 | m-ZrO₂, Mn₃O₄, NdMnO₃, Nd₂O₃ | 0.9 |
| Example 15 | 1 | 0.1 | m-ZrO₂, Mn₃O₄, NdMnO₃, Nd₂O₃ | 1.0 |
| Example 16 | 0.02 | 0.02 | m-ZrO₂ | 0.2 |
| Example 17 | 0.02 | 0.15 | m-ZrO₂, Nd₂O₃ | 0.8 |
| Example 18 | 0.4 | 0.02 | m-ZrO₂, Mn₃O₄ | 0.4 |
| Example 19 | 0.4 | 0.15 | m-ZrO₂, c-ZrO₂, Mn₃O₄, NdMnO₃ | 0.8 |
| Example 20 | 0.1 | 0.25 | m-ZrO₂, Mn₃O₄, NdMnO₃, Nd₂O₃ | 1.7 |
| Comparative | 0.11 | — | perovskite structure | — |
| Example 1 | | | | |
| Comparative | 0.02 | — | m-ZrO₂ | — |
| Example 2 | | | | |
| Comparative | — | 0.1 | m-ZrO₂, Nd₂O₃ | — |
| Example 3 | | | | |

As shown in Table 1, the monoclinic ZrO₂ crystal phase (denoted by m-ZrO₂ in Table 1) was identified in the catalysts of Examples 1 to 20, and crystal phases, such as Mn₃O₄, Mn₂O₃, Nd₂O₃, and cubic or tetragonal ZrO₂ crystal phase (denoted by c-ZrO₂ in Table 1) were also identified depending on the composition ratio. In addition, the perovskite crystal phase was identified in the catalyst of Comparative Example 1.

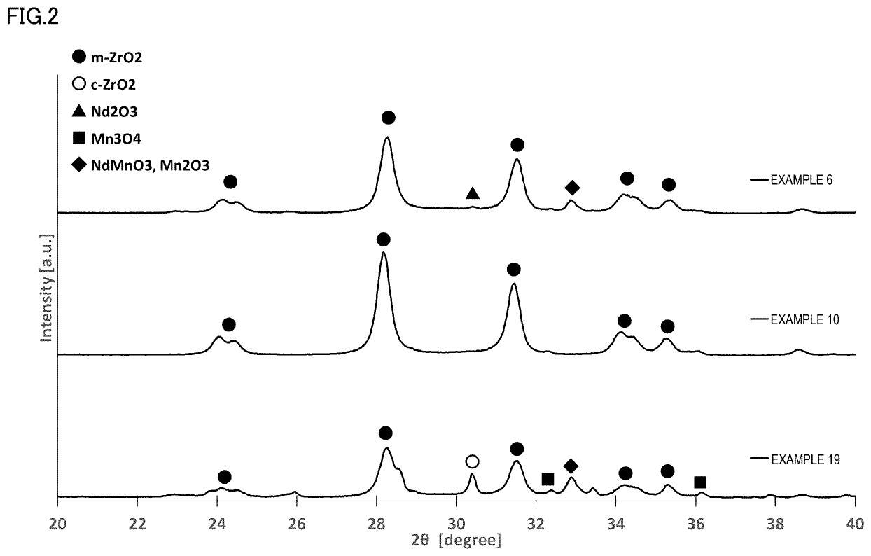

The XRD measurement results for Examples 6, 10, and 19 are shown in FIG. 2. In the Zr—Mn—Nd-based catalyst according to Example 6, m-ZrO₂, Mn₂O₃, and NdMnO₃ were detected, but Nd₂O₃ or Mn₃O₄ was not detected. This suggests that simultaneously adding Mn and Nd to ZrO₂ causes Nd and Mn to be incorporated into and highly dispersed in the monoclinic ZrO₂ crystal phase. In the catalyst of Example 10, not only Nd₂O₃ and Mn₃O₄ but also Mn₂O₃ and NdMnO₃ were not detected. This suggests that Nd and Mn are incorporated into and highly dispersed in the monoclinic ZrO₂ crystal phase. In the catalyst of Example 19 containing excess Mn and Nd, crystal phases, such as c-ZrO₂ and Mn₃O₄, were also detected. This suggests that the addition of excess Mn and Nd forms ZrO₂ structures other than monoclinic ZrO₂ and causes Mn and Nd to remain undispersed.

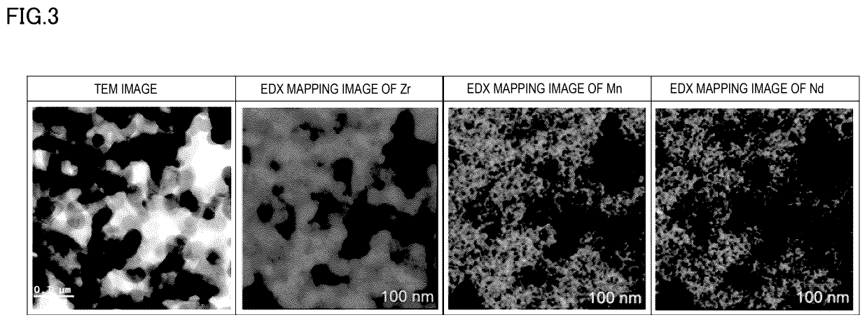

FIG. 3 illustrates the TEM (transmission electron microscope) image of Example 10 and the elemental mapping images of Zr, Mn, and Nd obtained by EDX (energy-dispersive X-ray spectroscopy) in the same field of view. The distributions of Zr, Mn, and Nd elements present in the catalyst particles of Example 10 coincide, suggesting a solid solution crystal structure in which Mn and Nd are dispersed and incorporated within the crystal lattice of zirconium oxide (ZrO₂).

### [Evaluation of Catalyst Initial Activity]

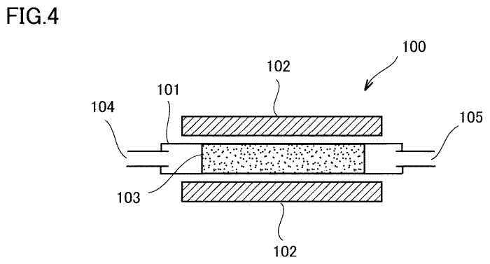

The toluene combustion reaction was carried out using the catalysts of Examples and Comparative Examples. An organic matter decomposition catalyst 103 (0.1 cc) was packed in a reaction pipe 101 of an organic matter decomposition device 100 illustrated in FIG. 4 and heated to a predetermined temperature by a heater 102. Air containing 1000 ppm toluene was introduced through a gas inlet 104 at a flow rate of 580 cc/min. During the test, gas after the reaction was collected through the reaction gas outlet 105, and the outlet toluene concentration [ppm] was measured using gas chromatography. The toluene decomposition rate was determined according to the following formula:

$$Toluene decomposition rate [ \% ] = ( 1000 - outlet toluene concentration ) \text{/1000}$$

The test was conducted while the test temperature was increased in 10° C. increments from 200° C., and the temperature at which the toluene decomposition rate reached 90% was defined as the “toluene 90% decomposition temperature.” The results are shown in Table 2.

### [Evaluation of Catalytic Activity After SO₂ Poisoning]

The catalysts of Examples and Comparative Examples were each subjected to SO₂ poisoning treatment. The organic matter decomposition catalyst 103 (0.1 cc) was packed in the reaction pipe 101 of the organic matter decomposition device 100 illustrated in FIG. 4 and heated to a temperature of 600° C. by the heater 102. Air containing 50 ppm SO₂ was introduced through the gas inlet 104 at a flow rate of 580 cc/min and maintained for 2 hours, followed by cooling. The “toluene 90% decomposition temperature” was then measured for the catalyst after SO₂ poisoning using the same method as in “Evaluation of Catalyst Initial Activity.” The results are shown in Table 2.

### [Evaluation of Catalytic Activity After Thermal Regeneration]

The catalysts of Examples and Comparative Examples were each subjected to poisoning treatment using the same method as in “Evaluation of Catalytic Activity After SO₂ Poisoning.” Subsequently, 0.1 cc of the organic matter decomposition catalyst 103 was packed in the pipe 1 of the organic matter decomposition device 100 illustrated in FIG. 4 and heated to a temperature of 800° C. by the heater 102. Air was introduced through the gas inlet 104 at a flow rate of 580 cc/min and maintained for 0.5 hours, followed by cooling. The “toluene 90% decomposition temperature” was then measured for the catalyst after thermal regeneration using the same method as in “Evaluation of Catalyst Initial Activity.” The results are shown in Table 2.

### Example 21

Pebbles, water, and an organic binder were added to the catalyst of Example 5, and the mixture was ground and mixed to prepare a catalyst slurry. A cordierite honeycomb (200 cpsi) was immersed in the prepared catalyst slurry for one minute, followed by air blowing to form a catalyst coating. Subsequently, the resulting honeycomb was dried in an oven at 120° C. and then calcined at 800° C. for 2 hours to obtain a catalyst-coated honeycomb of Example 21. The catalyst coating weight per honeycomb volume was 100 g/L.

### [Evaluation of Characteristics of Catalyst-Coated Honeycomb]

[Evaluation of Catalyst Initial Activity], [Evaluation of Catalytic Activity After SO₂ Poisoning], and [Evaluation of Catalytic Activity After Thermal Regeneration] were carried out using the same conditions as in Example 5, except that a 14-cell, 50-mm-long honeycomb catalyst for activity evaluation was cut from the catalyst-coated honeycomb of Example 21, and the catalyst-coated honeycomb of Example 21 was used as the organic matter decomposition catalyst 103. The results are shown in Table 2.

TABLE 2

| | Composition of Organic Matter | | | | |
|---|---|---|---|---|---|
| | Decomposition Catalyst | | Toluene 90% Decomposition | | |
| | Molar Ratio of | Molar Ratio of | Temperature (° C.) | | |
| | Mn to Zr in | Nd to Zr in | | | Activity |
| | Organic Matter | Organic Matter | | Activity | After |
| | Decomposition | Decomposition | Initial | After | Thermal |
| | Catalyst | Catalyst | Activity | Poisoning | Regeneration |
| Example 1 | 0.10 | 0.002 | 440 | 540 | 460 |
| Example 2 | 0.10 | 0.005 | 400 | 510 | 420 |
| Example 3 | 0.10 | 0.010 | 350 | 470 | 380 |
| Example 4 | 0.10 | 0.020 | 320 | 450 | 350 |
| Example 5 | 0.10 | 0.050 | 310 | 440 | 350 |
| Example 6 | 0.10 | 0.100 | 320 | 440 | 350 |
| Example 7 | 0.10 | 0.150 | 350 | 470 | 380 |
| Example 8 | 0.10 | 0.200 | 380 | 510 | 420 |
| Example 9 | 0.02 | 0.100 | 360 | 470 | 380 |
| Example 10 | 0.05 | 0.100 | 340 | 460 | 370 |
| Example 11 | 0.15 | 0.100 | 310 | 420 | 340 |
| Example 12 | 0.20 | 0.100 | 310 | 420 | 340 |
| Example 13 | 0.40 | 0.100 | 310 | 420 | 340 |
| Example 14 | 0.70 | 0.100 | 330 | 440 | 360 |
| Example 15 | 1.00 | 0.100 | 390 | 510 | 420 |
| Example 16 | 0.02 | 0.020 | 360 | 470 | 380 |
| Example 17 | 0.02 | 0.150 | 450 | 530 | 440 |
| Example 18 | 0.40 | 0.020 | 350 | 500 | 350 |
| Example 19 | 0.40 | 0.150 | 320 | 450 | 370 |
| Example 20 | 0.10 | 0.250 | 440 | 540 | 470 |
| Example 21 | 0.10 | 0.050 | 320 | 480 | 370 |
| Comparative | 0.11 | — | 390 | >700 | >700 |
| Example 1 | | | | | |
| Comparative | 0.02 | — | 500 | 580 | 510 |
| Example 2 | | | | | |
| Comparative | — | 0.1 | 520 | 630 | 550 |
| Example 3 | | | | | |

The organic matter decomposition catalysts of Examples 1 to 20 exhibited high catalytic activity in the initial activity, maintained high catalytic activity even in the catalytic activity after poisoning, and were successfully regenerated by heating even after being poisoned. The organic matter decomposition catalyst of Comparative Example 1 showed significant degradation of the decomposition performance due to SO₂ poisoning, and the toluene decomposition rate did not reach 90% even at a temperature of 700° C. The organic matter decomposition catalyst of Comparative Example 1 failed to recover its catalytic activity even after undergoing a thermal regeneration treatment at a temperature of 800° C. In Comparative Examples 2 and 3, none of the initial activity, the activity after poisoning, or the activity after thermal regeneration exhibited high catalytic activity.

In the catalyst-coated honeycomb of Example 21, poisoning progresses from the surface of the coating layer directly exposed to the flowing gas. Therefore, the catalyst-coated honeycomb of Example 21 tends to exhibit lower activity after poisoning than the particle catalyst (Example 5). However, the catalyst-coated honeycomb of Example 21 and the particle catalyst (Example 5) exhibited similar characteristics in terms of initial activity and recovery by regeneration treatment. The honeycomb catalyst can reduce the pressure drop during gas-flow reactions. For the particle catalyst (Example 5), the pressure drop during catalytic activity evaluation increased to 6 kPa. For the catalyst-coated honeycomb (Example 21), the pressure drop was successfully maintained at 1 kPa or less.

In the description of the embodiments described above, combinable configurations may be combined with each other.

The embodiments disclosed herein are for illustrative purposes in any respect and should not be construed as limiting. The scope of the present disclosure is defined by the claims, rather than the above description, and is intended to include all modifications within the meaning and range of equivalency of the claims.

It will be understood by those skilled in the art that the exemplary embodiments described above are specific examples of the present disclosure.

### REFERENCE SIGNS LIST

1 pipe
2 heater
3 controller
4, 104 gas inlet
5, 105 reaction gas outlet
6, 103 organic matter decomposition catalyst
7 gas supply pipe
8 gas discharge pipe
10, 100 organic matter decomposition device
41 organic matter supply line
42 nitrogen supply line
43 oxygen supply line
51 sampling line
101 reaction pipe
102 heater

1. An organic matter decomposition catalyst for oxidatively decomposing organic matter, the organic matter decomposition catalyst comprising:
a ternary composite oxide containing zirconium, manganese, and neodymium.

2. The organic matter decomposition catalyst according to claim 1, wherein a molar ratio of manganese to zirconium in the organic matter decomposition catalyst is in a range of 0.02 to 1.00.

3. The organic matter decomposition catalyst according to claim 1, wherein a molar ratio of manganese to zirconium in the organic matter decomposition catalyst is in a range of 0.05 to 0.70.

4. The organic matter decomposition catalyst according claim 2, wherein a molar ratio of neodymium to zirconium in the organic matter decomposition catalyst is in a range of 0.002 to 0.200.

5. The organic matter decomposition catalyst according claim 1, wherein a molar ratio of neodymium to zirconium in the organic matter decomposition catalyst is in a range of 0.002 to 0.200.

6. The organic matter decomposition catalyst according to claim 1, wherein a molar ratio of neodymium to zirconium in the organic matter decomposition catalyst is in a range of 0.010 to 0.150.

7. The organic matter decomposition catalyst according to claim 3, wherein a molar ratio of neodymium to zirconium in the organic matter decomposition catalyst is in a range of 0.010 to 0.150.

8. The organic matter decomposition catalyst according to claim 1, wherein the organic matter decomposition catalyst contains a monoclinic zirconium oxide crystal phase.

9. The organic matter decomposition catalyst according to claim 8, wherein the monoclinic zirconium oxide crystal phase is a first crystal phase and the organic matter decomposition catalyst further contains one or more second crystal phases.

10. The organic matter decomposition catalyst according to claim 1, wherein
in the organic matter decomposition catalyst, a molar ratio of manganese to zirconium is 0.05 or more and a molar ratio of neodymium to zirconium is 0.01 or more, and
when a (−111) plane diffraction peak intensity of monoclinic ZrO₂ in XRD is denoted by A,
a (011) plane diffraction peak intensity of Nd₂O₃ is denoted by B,
a (103) plane diffraction peak intensity of Mn₃O₄ is denoted by C, and
a (222) plane diffraction peak intensity of Mn₂O₃ or a (211) plane diffraction peak intensity of NdMnO₃ is denoted by D,
(B+C+D)/A is 0.9 or less.

11. The organic matter decomposition catalyst according to claim 1, wherein the ternary composite oxide is a first oxide, and the organic matter decomposition catalyst further comprises a second oxide.

12. The organic matter decomposition catalyst according to claim 11, wherein the second oxide is a single-component oxide or a binary composite oxide.

13. The organic matter decomposition catalyst according to claim 11, wherein an amount of the second oxide in the organic matter decomposition catalyst is 40 parts by mass or less per 100 parts by mass of the first oxide.

14. A honeycomb structure coated with the organic matter decomposition catalyst according to claim 1.

15. A method for decomposing organic matter, the method comprising:
oxidatively decomposing organic matter by heating the organic matter using the organic matter decomposition catalyst according to claim 1.

16. The method for decomposing organic matter according to claim 15, further comprising:
recovering a catalytic activity by heating the organic matter decomposition catalyst to a temperature higher than or equal to a heating temperature during the oxidative decomposition.

17. The method for decomposing organic matter according to claim 16, wherein the heating temperature is 300° C. to 900° C.

18. An organic matter decomposition device comprising:
a pipe through which organic matter flows;
a heater that heats the organic matter that flows through the pipe; and
the organic matter decomposition catalyst according to claim 1 within the pipe and that is heated by the heater.
